(19) United States
(12) Patent Application Publication
(10) Pub. No.: US 2011/0043467 A1
(43) Pub. Date: Feb. 24, 2011

(54) TIMING ADJUSTING METHOD FOR TOUCH SCREEN LIQUID CRYSTAL DISPLAY DEVICE

(75) Inventors: Ji Hun Kim, Daejeon-si (KR); Jung Il Seo, Daejeon-si (KR); An Young Kim, Daejeon-si (KR); Joon Ho Na, Daejeon-si (KR); Dae Seong Kim, Daejeon-si (KR)

Correspondence Address: Jae Y. Park, Kile Park Goekjian Reed & McManus PLLC, 1200 New Hampshire Ave. NW, Suite 570, Washington, DC, 20036, US

(73) Assignee: SILICON WORKS CO., LTD, Daejeon-si (KR)

(21) Appl. No.: 12/847,781

(22) Filed: Jul. 30, 2010

(30) Foreign Application Priority Data
Aug. 19, 2009 (KR) 10-2009-0076801

(51) Int. Cl. G06F 3/041

(52) U.S. Cl. 345/173

(57) ABSTRACT

Provided is a timing adjusting method for a touch screen liquid crystal display device. A liquid crystal module of the touch screen liquid crystal display device has a structure in which a data line connected to data pixels and a read line connected to read pixels are shared by a share line, and a display mode section for displaying data of the data pixels is performed separately from a read mode section for reading data of the read pixels.

### BACKGROUND OF THE INVENTION

1. Field of the Invention

The present invention relates to a timing adjusting method for a touch screen liquid crystal display device, and more particularly, to a timing adjusting method for a touch screen liquid crystal display device, which is designed to minimize the influence exerted between a display mode and a read mode when storing data in pixels and reading out touch information by using a liquid crystal module with a structure in which a data line connected to data pixels and a read line connected to read pixels form a single share line.

2. Description of the Related Art

With the recent development and popularization of a graphic user interface (hereinafter, referred to as a “GUI”) system, a touch screen liquid crystal display device having a simple input interface has been extensively used. The touch screen liquid crystal display device is an input device substituting for a keyboard and a mouse, in which if a user directly touches a touch panel mounted on a liquid crystal display panel by fingers, a desired operation is performed.

The touch screen liquid crystal display device allows a user to complete a business process in GUI environment such as a window operating system, which can be extensively used for an office automation field, a game application field, a mobile device field and the like.

Such a touch screen liquid crystal display device is classified into a resistive type, a capacitive type, an infrared type, an acoustic type, an electromagnetic type and the like. Recently, research into an integral type capacitive touch screen liquid crystal display device provided with a liquid crystal display panel having functions of a touch panel has been actively conducted in order to reduce the thickness of a touch screen liquid crystal display device.

The above-described touch screen liquid crystal display device basically includes a liquid crystal panel for displaying image information, a touch panel attached to the liquid crystal panel, a controller, a source driver IC and the like.

The capacitive touch screen liquid crystal display device has a configuration in which a plurality of plates corresponding to input keys are arranged on a substrate while being spaced apart from one another at a predetermined interval, and a voltage is applied to the plates. The capacitive touch screen liquid crystal display device operates in such a manner that when a person's finger touches a plate, it is determined that the plate has been selected by detecting parasitic capacitance according to dielectric constant between the finger and the plate or change in capacitance of a read pixel due to pressure, and a determined input signal is transmitted to a central processing unit (CPU) of a terminal, so that input corresponding to the input signal is performed.

FIG. 1 is a circuit diagram illustrating the structure of a liquid crystal module and a data driving circuit of a capacitive touch screen liquid crystal display device in accordance with the prior art.

Referring to FIG. 1, the liquid crystal module 110 of the capacitive touch screen liquid crystal display device in accordance with the prior art includes a plurality of gate lines G₁, G₂, Read_G₁ and G₃ formed on a substrate to transmit a gate signal, a plurality of data lines CH1 to CH4 for transmitting a data signal, and a read line CH_{READ} for reading stored information. It can be understood that the data lines CH1 to CH4 are separated from the read line CH_{READ}.

As shown in FIG. 1, in the liquid crystal module 110 of the conventional capacitive touch screen liquid crystal display device, since the data lines are separated from the read line, a channel output load of a data driving circuit SD-IC is uniform over all channels, so that an output waveform is also uniform. However, the liquid crystal module with the above structure is problematic in that aperture ratios of RGB data pixels are reduced as the number of read pixels is increased, and a large-sized liquid crystal panel is required.

In this regard, research and development into a touch screen liquid crystal display device with a structure of sharing a data line and a read line, and a timing adjusting method thereof when the touch screen liquid crystal display device is driven.

### SUMMARY OF THE INVENTION

Accordingly, the present invention has been made in an effort to solve the problems occurring in the related art, and an object of the present invention is to provide a timing adjusting method for a touch screen liquid crystal display device, which is designed to minimize the influence exerted between a display mode and a read mode in the touch screen liquid crystal display with a structure in which a data line and a read line forms a single share line.

In order to achieve the above object, according to one aspect of the present invention, there is provided a timing adjusting method for a touch screen liquid crystal display device, including: a liquid crystal module of the touch screen liquid crystal display device has a structure in which a data line connected to data pixels and a read line connected to read pixels are shared by a share line, and a display mode section for displaying data of the data pixels is performed separately from a read mode section for reading data of the read pixels.

According to a timing adjusting method for a touch screen liquid crystal display device in accordance with the present invention, a share line is initialized to a predetermined reference voltage before a read mode is performed, and the share line and a data line are initialized to a constant voltage before a display mode is performed, so that the influence exerted between the read mode and the display mode can be minimized.

### BRIEF DESCRIPTION OF THE DRAWINGS

The above objects, and other features and advantages of the present invention will become more apparent after a reading of the following detailed description taken in conjunction with the drawings, in which:

FIG. 1 is a circuit diagram illustrating the structure of a liquid crystal module of a capacitive touch screen liquid crystal display device in accordance with the prior art;

FIG. 2 is a circuit diagram illustrating a liquid crystal module with a structure of sharing a data line and a read line for applying a timing adjusting method of a touch screen liquid crystal display device in accordance with the present invention, and a data driving circuit;

FIG. 3 is a diagram illustrating a timing adjusting method for a touch screen liquid crystal display device in accordance with the present invention; and

FIG. 4 is a detailed diagram illustrating timing in a read mode of a timing adjusting method for a touch screen liquid crystal display device in accordance with the present invention.

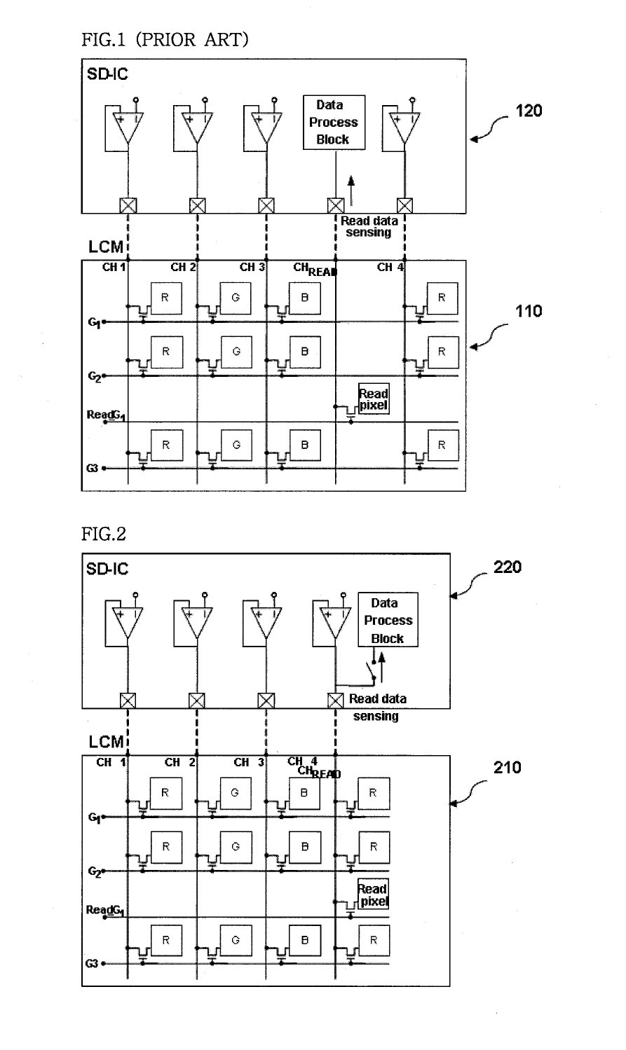

### DETAILED DESCRIPTION OF PREFERRED EMBODIMENTS

Reference will now be made in greater detail to a preferred embodiment of the present invention, an example of which is illustrated in the accompanying drawings.

FIG. 2 is a circuit diagram illustrating a liquid crystal module with a structure of sharing a data line and a read line for applying a timing adjusting method of a touch screen liquid crystal display device in accordance with the present invention, and a data driving circuit.

As shown in FIG. 2, the liquid crystal module 210 with the structure of sharing the data line and the read line includes a plurality of gate lines G₁, G₂, Read_G₁ and G₃ formed on a substrate to transmit a gate signal, a plurality of data lines CH1 to CH4 for transmitting a data signal, and a read line CH_{READ} for reading stored information. It can be understood that the read line CH_{READ} and the data line CH4 are shared.

Furthermore, it can be understood that in the structure of sharing the data line and the read line, the pads of the data driving circuit 220 connected to the share line are shared.

By the use of the structure of sharing the read line and the data line as described above, aperture ratios of RGB data pixels can be increased, the number of pads of the data driving circuit can be reduced, and the size of a chip can be reduced.

However, in the touch screen liquid crystal display device with such a structure, since the data line and the read line are shared, a display operation and a read operation may not be performed at the same time. In this regard, it is necessary to perform the operations by separating the display mode from the read mode, and to adjust timing such that the influence is prevented from being exerted between the display mode and the read mode.

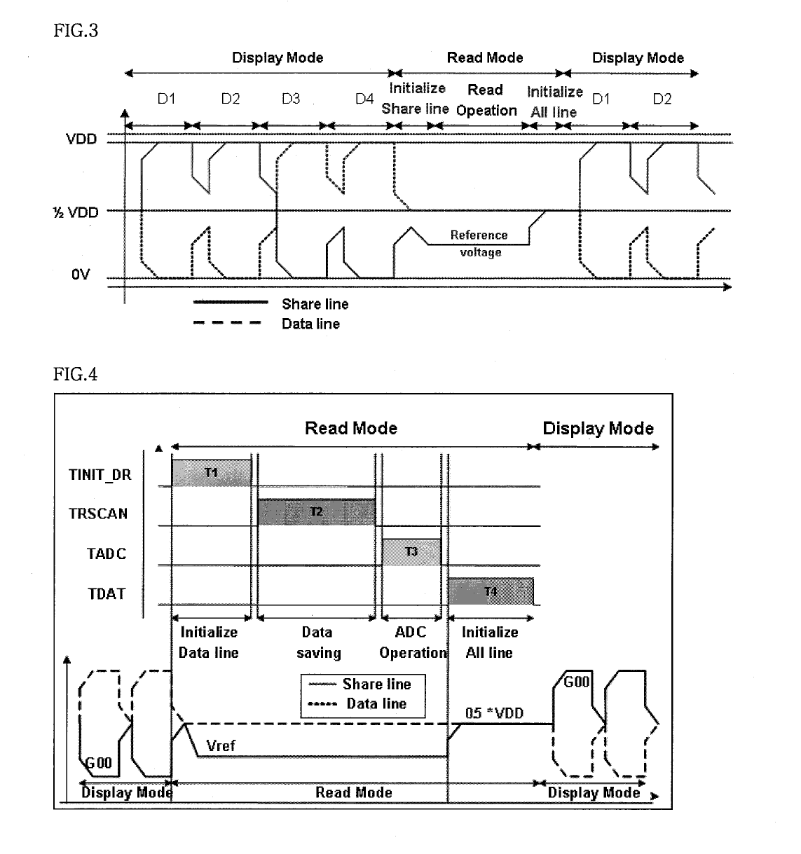

FIG. 3 is a diagram illustrating the timing adjusting method for the touch screen liquid crystal display device in accordance with the present invention.

As shown in FIG. 3, in the touch screen liquid crystal display device in accordance with the present invention, it can be understood that the display mode is separated from the read mode.

Referring to FIG. 3, in the display mode, the data line and the share line are driven by a vertical 2-dot inversion scheme. However, this is just one example. For example, the data line and the share line may be driven by various schemes such as a vertical 1-dot inversion scheme or a line inversion scheme.

The data line indicated by a dotted line has a negative (−) polarity in sections D1 and D2 of the display mode, and a positive (+) polarity in sections D3 and D4 thereof. In the read mode, since only the read pixels operate and the data pixels do not operate, the data line maintains a value ½ VDD corresponding to the half of a maximum operating voltage VDD of the liquid crystal display device.

In the read mode section, the data line may have a random value in the range of the maximum operating voltage VDD. However, it is preferable that the data line maintains the value ½ VDD corresponding to the half of the maximum operating voltage VDD in order to have uniform time at the time of subsequent data transmission.

When the read mode is ended and the display mode is performed again, the operations of the sections D1 to D4 are repeated.

Meanwhile, the share line indicated by a solid line has a positive (+) polarity in sections D1 and D2 of the display mode, and a negative (−) polarity in sections D3 and D4 thereof. When the display mode is ended and the read mode is performed, the share line is initialized to a predetermined reference voltage Vref before entering the read mode.

In the case of the share line, different data may be stored in the process of scanning data having a positive (+) polarity and data having a negative (−) polarity in the display mode, so that the different data is read out during the read mode operation, resulting in the occurrence of an error. For this reason, the share line is initialized to the predetermined reference voltage Vref in order to allow the data to have a uniform value.

Meanwhile, when the read mode is ended and the display mode is performed again, the share line and the data line are initialized to ½ VDD corresponding to the half of the maximum operating voltage VDD before entering the display mode, so that uniform time can be obtained at the time of subsequent data transmission.

FIG. 4 is a detailed diagram illustrating timing in the read mode of the timing adjusting method for the touch screen liquid crystal display device in accordance with the present invention.

As shown in FIG. 4, a timing sequence for the operation in the read mode may be divided into four durations T1 to T4.

First, in the share line initialization duration T1, data lines are allowed to maintain ½ VDD and share lines are initialized to the predetermined reference voltage Vref before a read-out operation is performed.

As described above, the data lines may be allowed to maintain a random voltage in the range of the maximum operating voltage VDD of the touch screen liquid crystal display device. However, it is preferable that the data lines maintain ½ VDD in order to have uniform time at the time of subsequent data transmission.

In the read-out duration T2, read pixels are turned on in response to a gate signal of the read pixels, and data of the read pixels of the touch screen panel is stored.

In the digital signal conversion duration T3, the stored data of the read pixels is converted into a digital signal by an analog-to-digital converter ADC. At this time, the data lines maintain ½ VDD and the share lines maintain the predetermined reference voltage Vref.

In the share line and data line initialization duration T4, the digital signal processed by the analog-to-digital converter ADC is transmitted to a timing controller, and simultaneously the share lines and the data lines are initialized to ½ VDD before entering the display mode.

As described above, before the read mode is performed after the display mode operation is ended, the share line is initialized to the predetermined reference voltage Vref, so that different data values stored during the display mode operation can be prevented from being read out during the read mode operation.

Furthermore, before the display mode operation is performed again after the read mode operation is ended, the share line and the data line are initialized to ½ VDD, so that uniform time can be obtained at the time of subsequent data transmission.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A timing adjusting method for a touch screen liquid crystal display device, comprising:
a liquid crystal module of the touch screen liquid crystal display device has a structure in which a data line connected to data pixels and a read line connected to read pixels are shared by a share line, and
a display mode section for displaying data of the data pixels is performed separately from a read mode section for reading data of the read pixels.

2. The timing adjusting method for the touch screen liquid crystal display device according to claim 1, wherein the read mode section includes:
a share line initialization duration for initializing the share line to a reference voltage after the display mode section is ended;
a read-out duration for storing and processing the data of the read pixels; and
a share line and data line initialization duration for initializing the share line and the data line to a predetermined operating voltage before a subsequent display mode section is started.

3. The timing adjusting method for the touch screen liquid crystal display device according to claim 2, wherein the read-out duration includes:
a read data storage interval for storing the data of the read pixels; and
a read data conversion interval for converting the stored data of the read pixels into a digital signal.

4. The timing adjusting method for the touch screen liquid crystal display device according to claim 2, wherein, in the share line and data line initialization duration, the share line and the data line are initialized to the operating voltage and simultaneously the digital signal is transmitted to a timing controller.

5. The timing adjusting method for the touch screen liquid crystal display device according to one of claims 2, wherein the operating voltage has a value corresponding to a half of a maximum operating voltage of the touch screen liquid crystal display device.

6. The timing adjusting method for the touch screen liquid crystal display device according to one of claims 3, wherein the operating voltage has a value corresponding to a half of a maximum operating voltage of the touch screen liquid crystal display device.

7. The timing adjusting method for the touch screen liquid crystal display device according to one of claims 4, wherein the operating voltage has a value corresponding to a half of a maximum operating voltage of the touch screen liquid crystal display device.
